(19) United States
(12) Patent Application Publication
(10) Pub. No.: US 2013/0097162 A1
(43) Pub. Date: Apr. 18, 2013

(54) Method and system for generating and presenting search results that are based on location-based information from social networks, media, the internet, and/or actual on-site location

(71) Applicants: Kelly Corcoran, Fort Lauderdale, FL (US); James Christhoper Bristow, North Palm Beach, FL (US); J. Chris Bristow, North Palm Beach, FL (US)

(72) Inventors: Kelly Corcoran, Fort Lauderdale, FL (US); James Christhoper Bristow, North Palm Beach, FL (US)

(21) Appl. No.: 13/544,956

(22) Filed: Jul. 9, 2012

Related U.S. Application Data
(60) Provisional application No. 61/505,749, filed on Jul. 8, 2011.

(51) Int. Cl. G06F 17/30

(52) U.S. Cl. CPC G06F 17/30241
USPC 707/724

(57) ABSTRACT

Method and system for generating and presenting search results that are based on location-based information from social networks, media, the internet, and/or actual on-site location.

### BACKGROUND OF THE INVENTION

Social Media is everywhere in our society. Our society is so advanced that we can now tell or announce or broadcast to people exactly what we are doing and where we are going in real time. These real time updates should help us make connections, positional updates, and real time decisions on how we spend our free time. Each social network has thousands of access points. With multiple networks there are millions of access points. Because of competing, adverse, or other interests, not all social networks or media are linked together. Just like the internet before the search engine, the realm of social networking, real time updates, positional updates, and historical social data becomes a disconnected black hole of useful data.

Several programs, applications, and social networking helpers have attempted to unify the social media networks. However, these programs often fail by attempting to obtain their own users, content, and data. There is no search engine, system, or method for displaying real time social data, trending social data, or predicting future social data. In addition, there is no search engine, system, or method that assists users in decision making based on real time and/or historical location based data. Lastly, there is no search engine, system, or method that uses historical social or location based data to predict future trends.

### SUMMARY OF THE INVENTION

The present invention generally relates to data processing, and more particularly but without limitation, to a method and system for generating and presenting search results that are based on present and/or historical location based information from social networks, media, the interne, and/or actual on-site location—including but not limited to: Facebook, Google Places, Twitter, Foursquare, Tumblr, Instagram, etc. Using present and/or historical location based data this system can predict trends and assist users in decision making.

It is to be understood, however, that there is no intention to limit the invention to the forms described herein. One skilled in the art can recognize that there are numerous modifications, equivalents, and alternative constructions that fall within the spirit and scope of the invention expressed herein. Further, it should be noted that the present invention may comprise systems having different architecture that than shown below.

### DESCRIPTION OF DRAWINGS

FIG. 1 is an example of a logical flow diagram for a relative search query under the system.

FIG. 2 is an example of a user interface where a user searches based on a defined location. Following to

FIG. 3 is where the user has imputed a defined location (e.g. Tampa, Fla.) and all the social POIs have come up near the user in Tampa, Fla.

FIG. 4 is an example of how the user can then narrow its selection to a specific category/taxonomy of a POI.

FIG. 5 is an example of a user selecting a “Mexican Restaurant” as the category. The system notifies the user of the social connections, or second users, who have commented on each particular POI.

FIG. 6 shows a sample of second users or connections at the POI (e.g. restaurant X).

FIG. 7 shows what a particular second user said about the POI.

FIG. 8 is an example of the embodiment that uses real time and historical data to predict trends.

### DESCRIPTION OF THE INVENTION

In one embodiment, a search engine implements a method compromising of receiving a search query, determining a general result for said search query, determining a specialized result based on the various location based data available on the interne by using the search query, and providing a search result for the search query based at least in part on the general result and the specialized result.

There is a lot of data from the social network media that can be used to adjust a raw locations or Points of Interest (“POI”) ranking.

The first type of data is referred herein as “second users”. “Second users” are users of various social media networks, i.e., Facebook, twitter, Foursquare, etc.

The second type of data is referred herein as “second users' locations.” “Second users' locations” is the real time or close to real time geographic location of second users. “Second users' locations” can also be the geographic location of second users in the past.

The third type of data is “second users' information”—which is a given second users' social media information, i.e., social network preferences, demographics, sex, age, geography, height, weight, hair color, eye color, gender, relationship status, objective, etc.

The fourth type of data is a measure referred herein as “trend.” “Trend” is a measure of a given Point of Interest's (“POI”) historical data, which, may or may not, include application of an algorithm.

“Location based data”, includes but is not limited to, the above types of data.

There are endless variants on the specific approach to accessing, creating, and using social network media data to ranking POIs. In some embodiments, the manner of accessing, creating, and using social network media data may be different than described herein.

Example embodiment provides systems and methods for ranking POIs based on real time, location-based social network/media information.

Example embodiment provides systems and methods for ranking POIs based on past second users' information.

Example embodiment searches various social media networks based on a location, which can be inputted by a user or automatically read from the user's device. It can search anonymously or it can socially search based on a user's account linked to social media networks. Anonymously the results can display the most popular places near the user, which can be limited to certain demographics or taxonomy of POI. The search results may be instead or further sorted or limited based on second users' information that are within the search results, i.e., social network preferences, demographics, sex, age, geography, height, weight, hair color, eye color, gender, relationship status, objective, etc. This gives the user the results they are looking for and helps the user make a choice on where to spend free time.

In another embodiment, the user will also be able to socially enable the present invention to search from their social connections online to find the information. For example, one embodiment will allow the user to search anonymously or to be connected to a search engine via a social network(s), social groups, social applications, or other social connections. Therefore, the standard results will differentiate on whether the user is connected to social media or not.

Example embodiment may create, access, and use a POI database. The POI database is an aggregated database of all POIs (or locations)—which includes, i.e, name, address, phone number, etc.—and can be user extensible. The content in the POI database is organized according to taxonomy and geographic location, i.e., latitude and longitude. The POI database is from multiple sources and aggregated for use, i.e., scraped from various websites, check-in applications, and APIs, i.e., Yelp, Foursquare, Facebook, Twitter, etc. Some of the sources provide data via licensed data feeds, while other sources provide content that can be accessed from real simple syndicate feeds or other web-based APIs. Rules are applied to verify a given POI and the accompanying POI data, i.e, name, address, phone number, etc., to ensure the POI and POI data are correctly associated across the various sources even when a POI is characterized and represented differently among various sources. Further, the POI database allows for creation of new POIs and for the modification of existing POIs in the POI database. The data stored in the POI database may be updated frequently.

The location can be an actual location, physical location, hosted location, or a virtual location. While these location categories are separate, they can often overlap. An actual location can be identified on a global positioning device and it would have a physical longitude and latitude. A physical location can be a nondescript location, such as “home”, “restaurant”, or “work.” A hosted location is a special event that is hosted by an individual entity, such as charity event, super bowl, or theme park. A virtual location can be something that is available online, such as webpage event, chat room, or another virtual place. Location can used interchangeably with POI throughout this document.

In one embodiment, the POI database will include all historical data of the amount of prior visits to a given POI by a second user(s) and said second user's information. In one embodiment, a method will use said data to rank POIs based upon “trend.”

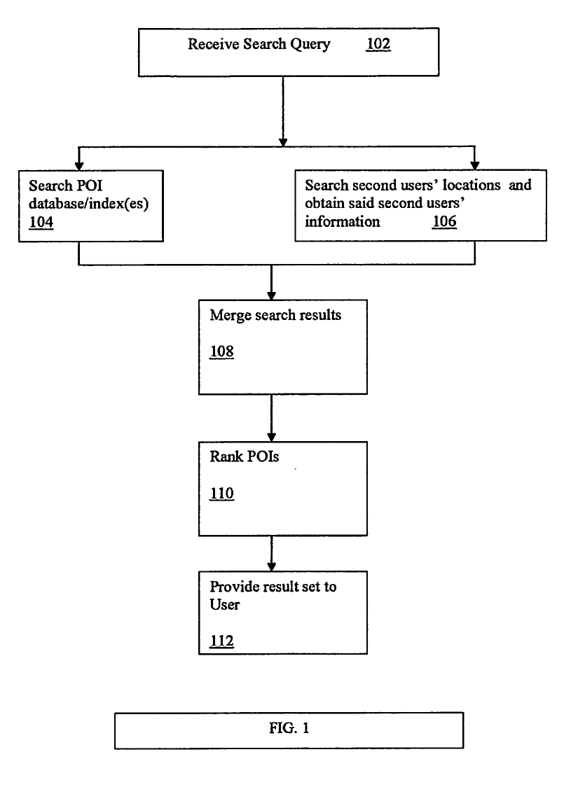

In another embodiment, the present invention may combine conventional network searches with, for example, personalized searches utilizing information provided by the user previously or in conjunction with the submission of the search. In the embodiment shown in FIG. 1, the search engine receives a query signal from a client 102. For example, in this embodiment the search query includes the user's geographic location or user-defined location; the taxonomy of the POI; and, user-defined radius for said taxonomy of POI. The search engine responds a query signal by performing a search. In the embodiment shown, the search comprises of two sub-processes, which may run parallel. These searches comprise: searching POI database/index(es) 104, searching second users' location within the user-defined radius and obtaining said second users' information 106. Other embodiments may include a sub-process to determine paid advertisements. Other embodiments may include a fewer or greater number of sub-processes which may be dependent on the search query.

Each of the sub-processes 104 and 106 shown may generate a separate result set. In other embodiments, the sub-processes 104 and 106 may be combined and/or configured to provide a combined result set automatically. In the embodiment shown, the search engine merges the search results into one list 108. The search engine then ranks the POIs 110. Various methods may be utilized to rank the POIs. For example, the search engine may rank results based upon number of second users at a POI within a defined time frame. The search engine than provides a sorted result set to the user requesting the search 112. Embodiments may also utilize other data, such as second users' information, i.e., social network profile data: gender, age, etc., to determine the ranking of the results, to mark the results, or for other purposes.

For example in one embodiment, the user may wish to have the results sorted or limited by only their social network friends which are connected by an nth degree.

In another embodiment, the user may wish to have the results only if a user's social network friends are near by or where said social network friends have been near that user recently.

In another embodiment, the method includes receiving the geographic location information of the user based on various location based services in the user's mobile device or computer (e.g., GPS or WiFi positioning), receiving a search query for certain taxonomy of a POI, receiving a user-defined radius of the user's geographic location for which said taxonomy of a POI should be within said radius, determining a set of POIs within the user-defined radius and user-defined taxonomy of a POI, determining what second users are located at the set of POIs within the user-defined radius and user-defined taxonomy, and providing a search result for the search query by ranking the POIs based upon the number of second users at said POIs that are within the user-defined radius and user-defined taxonomy.

In another embodiment, the method includes receiving the geographic location information of the user from the user's input device, global positioning system, or mobile position system, receiving a search query for certain taxonomy of a POI, receiving a user-defined radius of the user's geographic location for which said taxonomy of a POI should be within said radius, determining a set of POIs within the user-defined radius and user-defined taxonomy of a POI, determining what second users were located at the set of POIs within the user-defined radius and user-defined taxonomy (based upon POI historical data), and providing a search result for the search query by ranking the POIs based upon the number of second users that were at said POIs that are within the user-defined radius and user-defined taxonomy.

In another embodiment, the method and systems will be able to give a prediction of the amount of people or second users at a POI based upon data stored in a database of the amount of second users, i.e., historical data, at a queried day and time. POIs can then be ranked based upon the predicted number of people or second users and then subjectively re-ranked by the user based upon the predicted second user information. This embodiment will help use the location based data to help the user make decisions.

In another embodiment, an anonymous user will be able to enter a location. When searching anonymously the user inputs a location and the results will display the most visited place in that location and near that location. If there are no results for that location, the results display the most relevant location in the vicinity or with a similar name. If the user searchers for an actual or virtual location, then the results will display information about the prior visitors/second users of that location, such as age, gender or other demographics as stated above. The results will then show places near that location which are similar nature and/or had similar visitors.

In another embodiment, the socially adapted user inputs a specific location or POI, the results will return social friends, connections, or social networking peers who were at that specific location or POI or who have been to that specific location or POI. One embodiment will show real time results of social connections at any location. If no real time results are available, one embodiment will display social network friends (associated users) who have recently visited the location. One embodiment will show real time results of second users at that location. A user will be able to see when a social friend visited the location, who was there when they visited the location, and what they said about the location. The social adaptation will also recommend locations in the area based on friends/connections previous use.

In another embodiment, social adaptation occurs when the user logs in through social media accounts. A user can login with any social media network. The system will accept any social network and if the social network entered by the user is not recognized, it will automatically be added to the database. Once a user logs in with one network and adds another network to the users account, the networks will be linked in a database. In the future, users will be able to login through any of the users linked networks. This provides continuity through the different networks without requiring the user to remember another name, password, login, or account information. Once social adaptation is enabled, the user will have the option of broadcasting, announcing, or rebroadcasting their location, results, and decisions they gained from the use of the present invention.

Another embodiment displays search results with some kind of marking or logo that represents a user's social network friend(s) are there.

Another embodiment displays search results on a map with locations of all of the user's social network friends that are within the search results.

In another embodiment, there may be two types of searches (1) a search for a category/taxonomy of a POI/location within a pre-defined or user-defined radius of the user's current location or based upon the user defined address or zip code; or, (2) a specific POI/location—user inputs a name, zip code, city, state, or address. If a category/taxonomy is selected, then a search for all POIs/locations within the selected radius that are within the user defined category/taxonomy are searched and Index A is created. The list of POI/locations, i.e., POI database, are scraped from various websites, check-in applications, and APIs, i.e., Yelp, Foursquare, Facebook, Twitter, etc. Next a search is ran to determine what second users are (or have checked in to a POI/location within the a determined set of time) within the selected radius using check-in app's and various social networks' API to create Index B. Then Index B is compared to Index A to create Index C which then is only the POI/location with the list of people/second users there, which is then ranked by most people/second users at the given POI/location. Then Index C is compared to Index A, and any POI/location not on Index C but on Index A is then put into Index D. Index D is then ranked based upon number of total check-ins ever by second users. Then Index E is created by taking the demographics of the people/second users at the POIs/locations based on Index C. Then the user gets the results. By default, Index C is displayed first in its entirety followed by Index D. The user has the option to then sort or limit the results based upon the demographics of the people/second users checked in at the POI/locations in Index C, i.e., gender, age group, marital status, etc. If done, then Index E is accessed and the POIs/locations are displayed in ascending or descending order of the user defined demographic.

In another embodiment, the user can then click on any given POI/location within the results. That will then bring the user to that POI/location's landing page. This page will give a map of the POI/location; people there with picture scraped from their respective source; pie chart of gender, age group, marital status, etc.; how many people were there this time yesterday; how many people were there this time last week; any possible trending; predictions regarding the amount of people there in the future; other users reviews, etc.

Also, if the user has given permission to access their social networks, then their friends from said social networks are the first pictured followed by non-friends.

If a particular POI/location is searched, then only a search is ran using check-in app's and website's API to determine what users are (have recently checked into a location within a pre-defined time period) at that user defined POI/location. Then the user is taken directly to the landing page, see above. If the user defined POI/location is not located, then the user is given nearby locations or the option to add the POI/location to the database

In another embodiment, users can make a POI/location their favorite. Users then quickly just look at their favorites. Also, users will have the option to have their favorites higher on the results when that specific favorite is within the search radius. Users who have favorites can receive real time notifications when there is any activity at a POI/location on the user's favorites.

These systems and methods and given embodiments can be applied to a web-browser, mobile device, or other platforms.

### Realtime Reviews

In another embodiment, user can access real time reviews for any location when user searches for said location. User will be able to get his/her social connections' user generated content as well as anonymous user generated content and professional generated content about the specific location. User generated content will be stored in a database. Professional generated content or outside generated content will be accessed via licensed data feeds, while other sources provide content that can be accessed from real simple syndicate feeds or other web-based APIs. That way user can make an informed choice about the location and what to do at the location.

### GUIS and API

Guided user interfaces (GUI) and application programming interface (API) is a web service that provides similar functionality as a search form web page as it accepts search parameters including the taxonomy/category of the search, the location to base the search on, and the radius of the search. The API will further allow for multi-stage search capability by allowing a filtering or narrowing of the search based on second users' social network preferences, demographics, sex, age, geography, height, weight, hair color, eye color, gender, relationship status, and objective. These will also allow the user ease in adding social networks, sorting search results, and choosing how to search. The GUIs and API will provide the user with the option of focusing the search. They will also allow the user to enter their own user content. The GUIs and Apps will also allow the user to browse a location in any given region after performing a search for that location in the region.

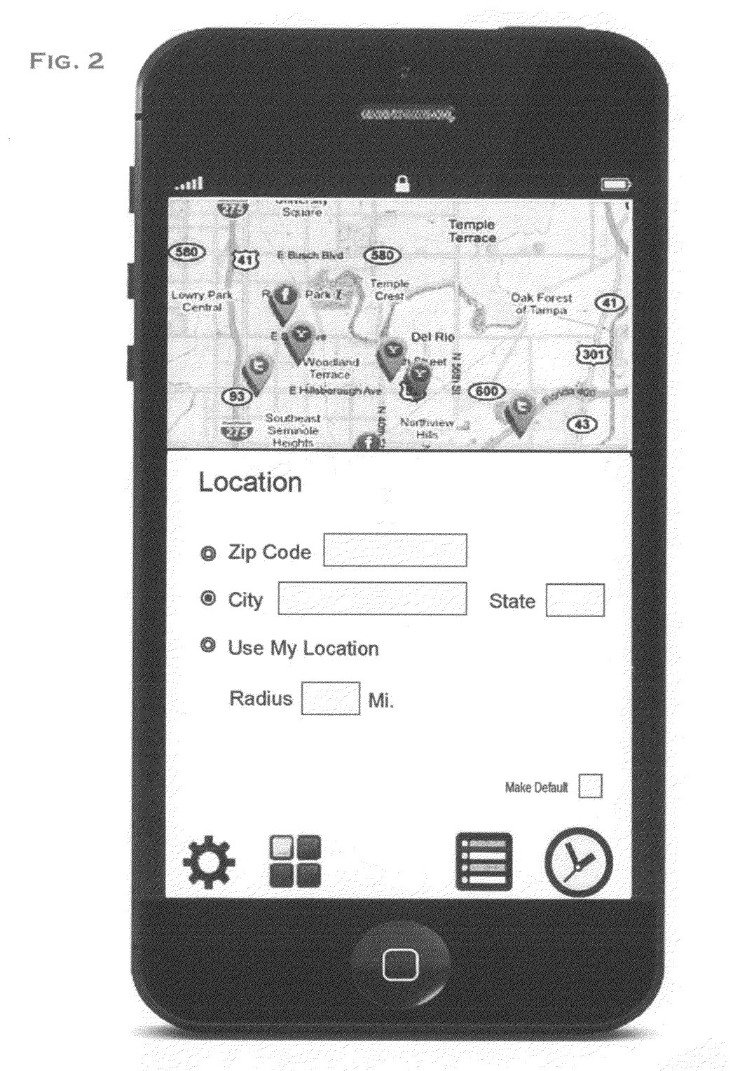

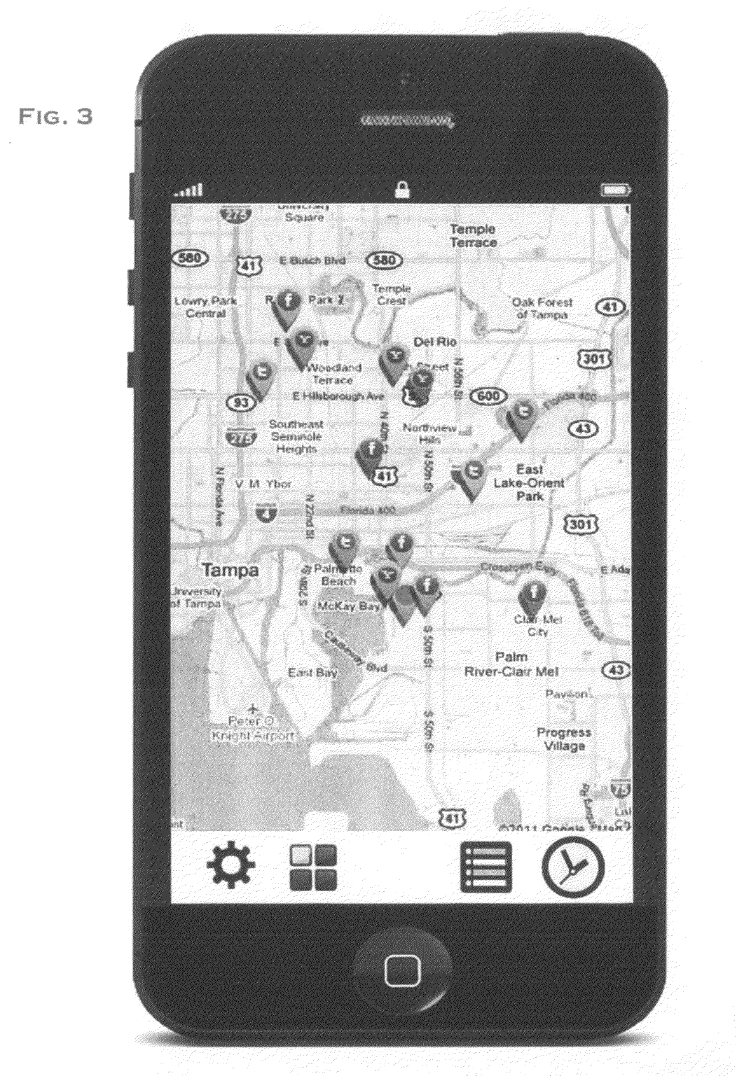

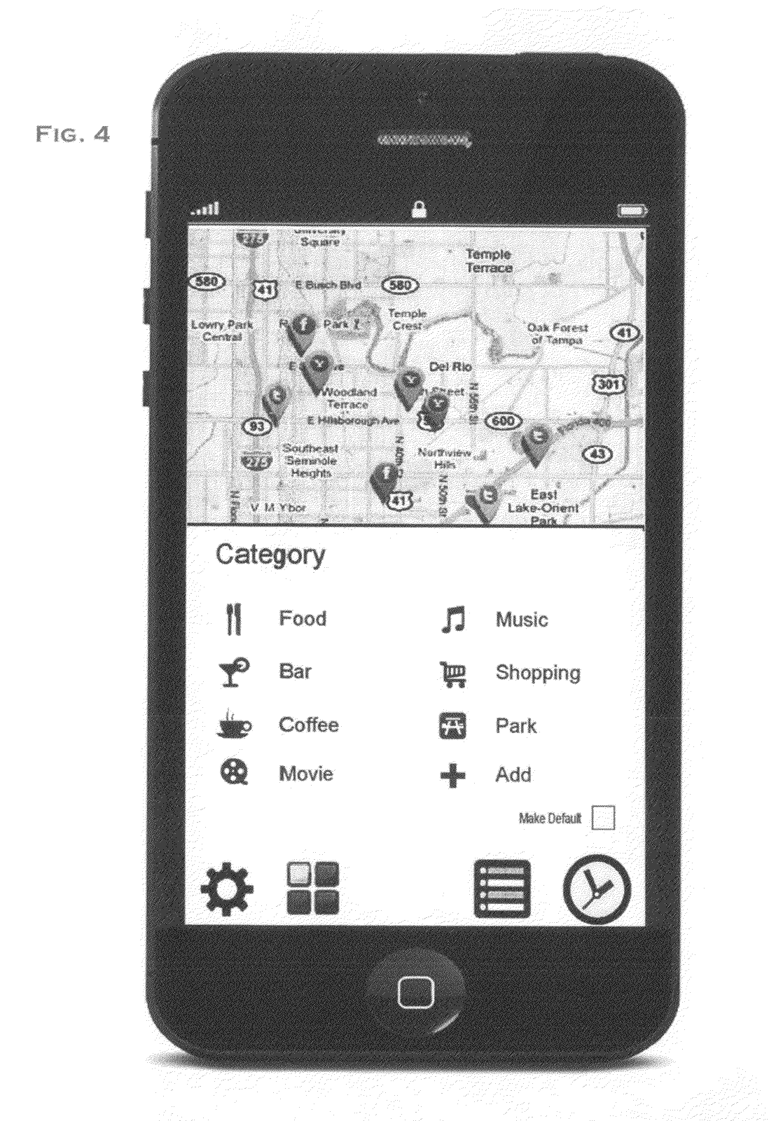

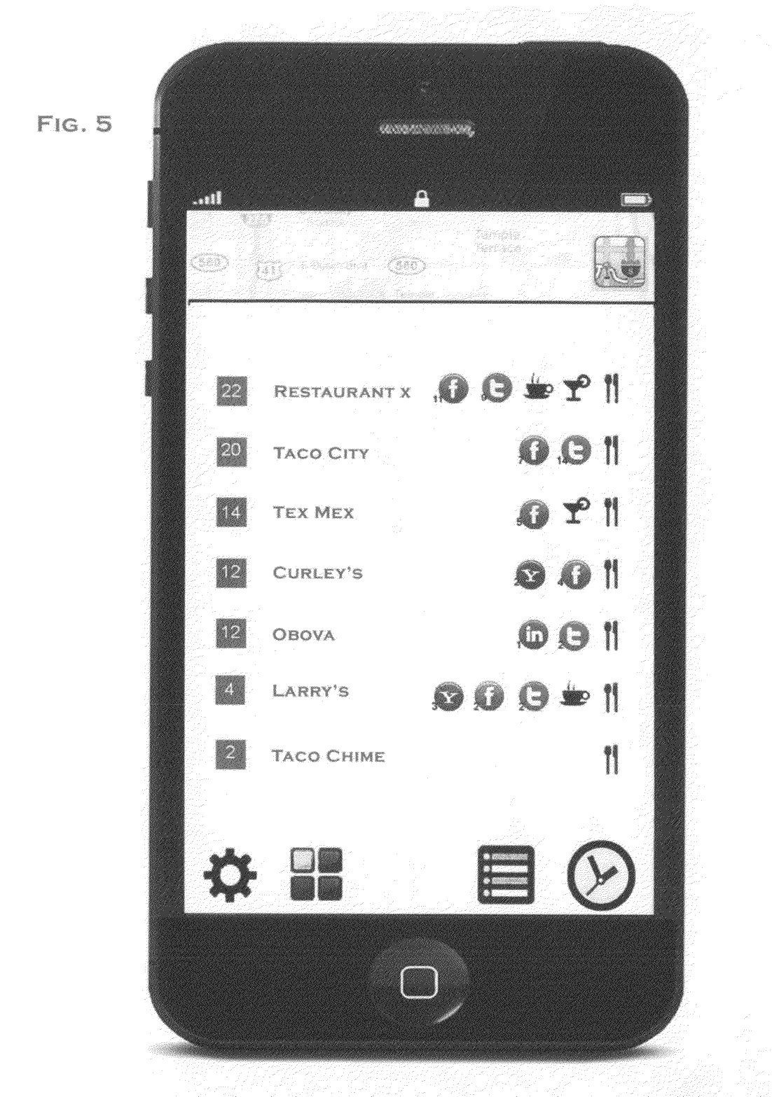

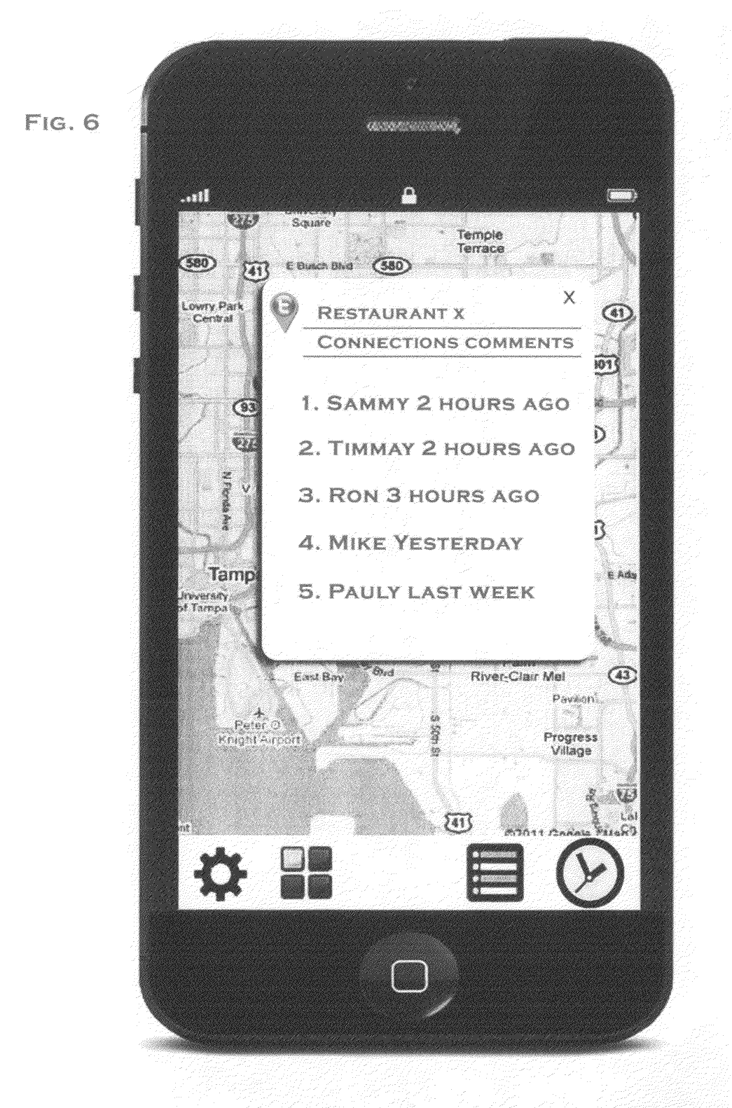

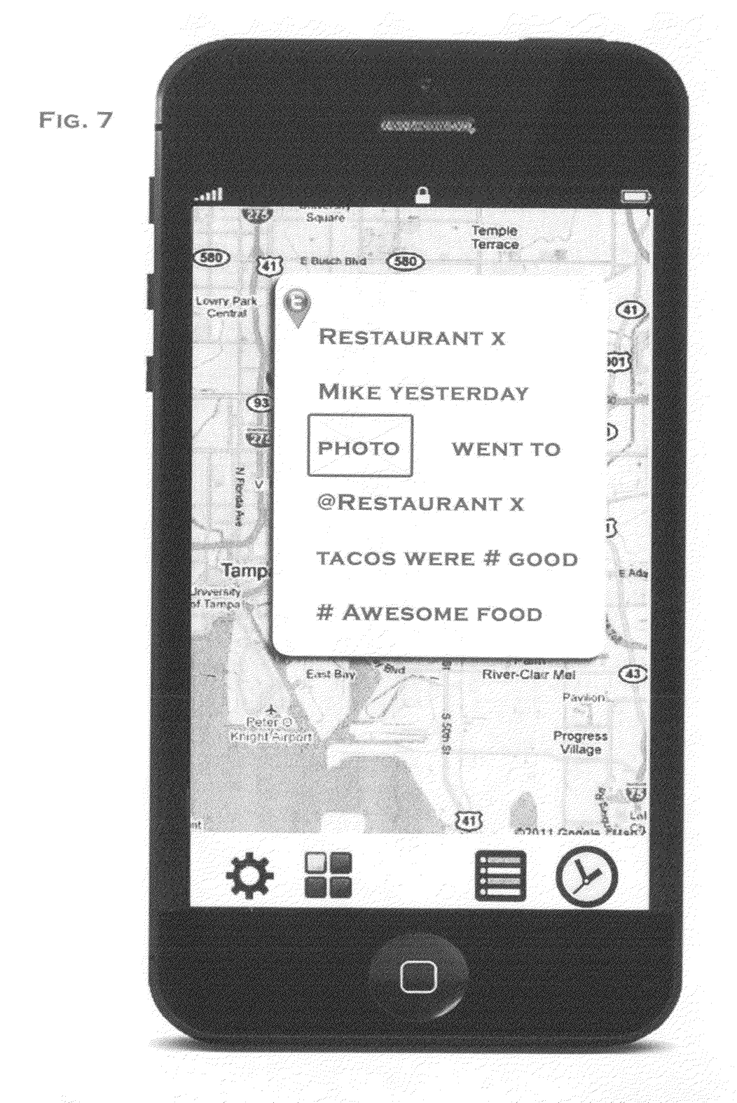

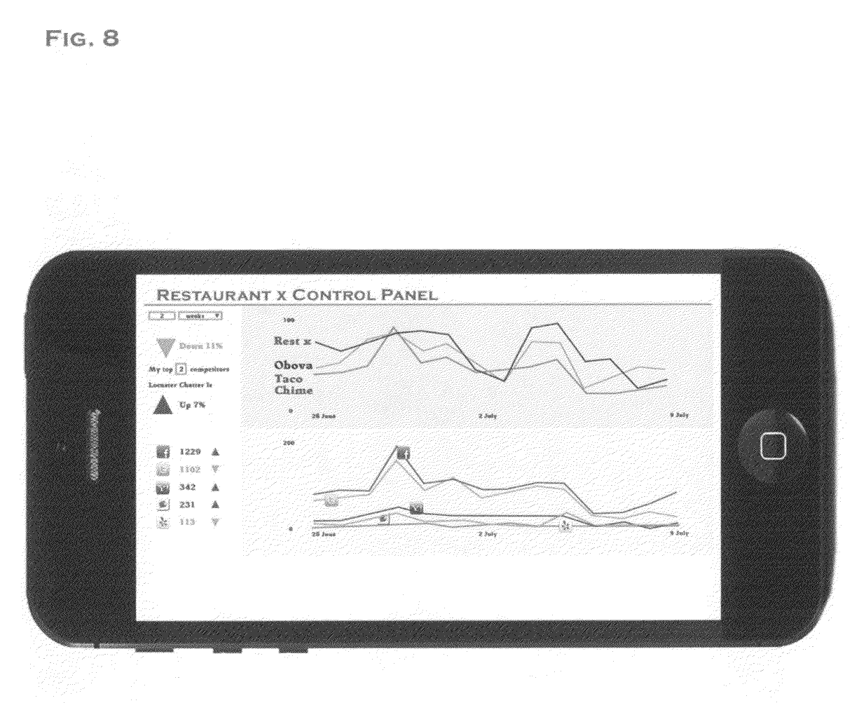

FIG. 2 is an example of a user interface where a user searches based on a defined location. Following to FIG. 3 is where the user has imputed a defined location (e.g. Tampa, Fla.) and all the social POIs have come up near the user in Tampa, Fla. FIG. 4 is an example of how the user can then narrow its selection to a specific category/taxonomy of a POI. FIG. 5 is an example of a user selecting a “Mexican Restaurant” as the category. The system notifies the user of the social connections, or second users, who have commented on each particular POI. FIG. 6 shows a sample of second users or connections at the POI (e.g. restaurant X). FIG. 7 shows what a particular second user said about the POI. FIG. 8 is an example of the embodiment that uses real time and historical data to predict trends.

In conclusion, the present invention provides, among other things, a method and system for generating and presenting search results that are based on real time location-based data as well as historical location-based data from various sources discussed herein. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms.

1. A method, comprising: receiving, at a computer system or device, a search request comprising of a geographic location and user defined radius to search for Points of Interest from the geographic location; accessing a Point of Interest database to identify a set of POIs within the user defined radius of said geographic location; accessing, for each POI in the set, a set of second users based upon the second users' location as it relates to the POI; accessing, for each second user in the set, the second user location and second user information; ranking the POIs in the set based upon the number of second users at the POIs within a defined time period; and, presenting the ranked list of POIs.

2. The method of claim 1 wherein a user identifier associated with a user is received.

3. The method of claim 1 wherein a category/taxonomy of a Point of Interest is received and the POI set is to include only POI within the user defined category/taxonomy.

4. The method of claim 2 wherein a set of associated users is composed of: accessing a social graph against the user identifier; identifying, from the set of second users, one or more social network connections which are associated with the user by a pre-determined degree of separation; and, ranking the POIs in the set based upon the number of associated users.

5. The method of claim 1 wherein the geographic location can be user defined or based upon global or mobile positioning system.

6. The method of claim 2, wherein the user can update a POI using a social network or existing resource.

7. The method of claim 1, wherein the engine uses the second user information to provide personalized search results for subjective re-ranking of the POI set.

8. A method of claim 1, further comprising of: receiving, at a computer system or device, a search request comprising of a geographic location, user defined radius within said geographic location to search for Points of Interest, and a day and time in the future; accessing a Point of Interest database to identify a set of POIs within the user defined radius of said geographic location; accessing, for each POI in the set, the POI historical data, which includes second user location and second user information; applying algorithm to POI historical data from POI set based upon user defined day and time in the future; ranking the POIs in the set based upon algorithm applied to POI historical data which predicts the number of second users at the POIs in the set for the user defined day and time in the future; and, presenting the ranked list of POIs.

9. The method of claim 8 wherein a user identifier associated with a user is received.

10. The method of claim 8 wherein a category/taxonomy of a Point of Interest is received and the POI set is to include only POI within the user defined category/taxonomy.

11. The method of claim 9 wherein a set of associated users is composed of: accessing a social graph against the user identifier; identifying, from the set of second users, one or more social network connections which are associated with the user by a pre-determined degree of separation; and, ranking the POIs in the set based upon the number of associated users.

12. The method as recited in claim 2, further comprising: tracking the user's search query, POI set, ranking of POI set, and the user's activity at each POI associated with the search query; storing said data in POI historical database; analyzing the utilization of the ranking of POI set by user and the user's selection of POI; and, predicting future activity at the POI based on historical data about the POI based on recommendation algorithm.

13. The method of claim 12, further comprising: ranking POI set based on recommendation algorithm; and, presenting the ranked list of POIs.

14. The method as recited in claim 9, further comprising: tracking the user's search query, POI set, ranking of POI set, and the user's activity at each POI associated with the search query; storing said data in POI historical database; analyzing the utilization of the ranking of POI set by user and the user's selection of POI; and, predicting future activity at the POI based on historical data about the POI based on recommendation algorithm.

15. The method of claim 14, further comprising: ranking POI set based on recommendation algorithm; and, presenting the ranked list of POIs.
